(19) United States
(12) Patent Application Publication
(10) Pub. No.: US 2014/0156361 A1
(43) Pub. Date: Jun. 5, 2014

(54) System and method for coupling receipt information with packaging

(71) Applicant: Sean P. Hughes, Pittsburgh, PA (US)

(72) Inventor: Sean P. Hughes, Pittsburgh, PA (US)

(21) Appl. No.: 13/690,864

(22) Filed: Nov. 30, 2012

(51) Int. Cl. G07G 5/00

(52) U.S. Cl. CPC G07G 5/00
USPC 705/14.4; 705/24; 705/15

(57) ABSTRACT

The described method combines a transaction receipt and packaging. In this way the problem of having the bag and receipt as separate items is solved. The problem of having a separate receipt for a purchase is solved by printing the receipt on the bag, pizza box, tray liner, or other type of packaging.

### FIELD

This invention generally relates to the field of point-of-sale checkout devices.

### BACKGROUND

Currently, when checking out from nearly every retailer, a customer leaves the transaction with her purchased goods, a receipt, and a plastic or paper bag. The receipt is often discarded or lost, resulting in either additional waste or difficulty in returning the purchased goods.

In fast-food restaurants a receipt must either be stapled to a bag or laid upon a tray liner to allow the employees to know which bag or tray should hold which food. Stapling the receipt to the bag or placing it on the tray liner is an error-prone and time consuming solution.

### SUMMARY

Recognizing the problem described above, the solution is to avoid having the bag and transaction receipt as separate items. In accordance with the invention, the problem of having a separate receipt for a purchase is solved by printing the receipt on the packaging.

Many advantages exist to the combination of the receipt and the packaging. Paper and plastic consumption is reduced, the receipt is kept with the goods to allow for simpler returns and exchanges, transaction time is lessened because the clerk does not need to handle the receipt separately only to hand the bag/receipt combination to the customer, and the workflow internal to the retailer or restaurant is simplified and thus more error tolerant.

Printing the receipt upon the packaging at the time of the sale is a solution to many problems that exist in the retail and food industries.

A separate receipt is no longer required after a purchase because the receipt is printed directly on the packaging, whether a bag, tray liner, or other associated packaging.

Paper is not unnecessarily wasted by the creation of a separate receipt because the receipt is combined with the packaging.

The proof of purchase of the good, in the form of a receipt, is no longer easily lost because it is combined with the product packaging.

To avoid the problem within fast-food restaurants of mixing up which food belongs with which bag, the receipt information is printed on the packaging before sending it through the food preparation area.

### BRIEF DESCRIPTION OF THE DRAWINGS

The invention can be best understood by those having ordinary skill in the art by reference to the following detailed description when considered in conjunction with the accompanying drawings in which:

FIG. 1 is a flow diagram showing a method for gathering order information and combining it with the packaging.

FIG. 2 is a flow diagram showing a method within a fast-food restaurant for gathering order information and combining it with the packaging.

FIG. 3 is a flow diagram showing a method for gathering order information and combining it with the packaging before passing it through the order preparation portion of a restaurant.

FIG. 4 is an overhead schematic of a restaurant.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

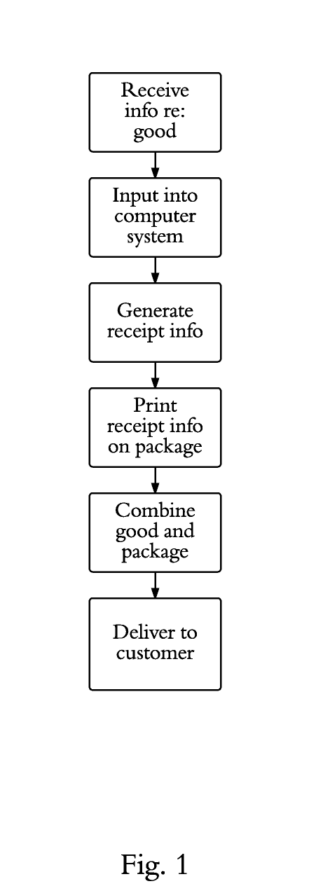

Referring to FIG. 1, a method for gathering order information and combining it with the packaging is shown.

The first step is to receive information regarding the desired goods. This can be a customer at a counter telling an employee which menu items are desired, a customer bringing certain items from a hardware store the counter, a telephone call from a customer with an order, or information gather from the internet.

The second step is inputting this information into a computer system. The computer system has both data storage and computing capability. The computer system includes the ability to accept input regarding the desired goods. This can be in the form of a keyboard, keypad, touchscreen, barcode scanner, Radio Frequency IDentification (RFID) tag, Ethernet, wireless, or other type of data collection device or data connection.

The third step is generation of the receipt information for the transaction, or the transaction receipt, by the computer system. Receipt information is comprised of numerous pieces of information, including the common name of a good, identification number, price, quantity, date of purchase, name of seller, name of buyer, credit card information, type of payment, quantity of payment, tax rate, tax amount, receipt identification number, cash register identification number, or other purchase-related information.

The generated receipt information will be passed to the receipt printer, thus the information that is relevant will vary depending on the use. For example, in a fast-food restaurant the important receipt information includes the item name and quantity, with the ingrediates likely being unimportant. Cash register identification may be important to determine which register the completed order should be passed to.

The fourth step is printing the generated receipt information on the packaging. This can be performed by any printer that is equipped to print on packaging. A modified printer may be required to deal with the complexity of feeding a paper bag or plastic bag through the path of a printer head. If the printing is to be done on a tray liner, the printing process will be less complex. Any type of packaging can be printed upon, including pizza boxes, paper bags, plastic bags, cardboard food containers, plastic food containers, Styrofoam food containers, drink cups, etc.

Additionally, some items facilitate being directly printed upon. For example, when an order for a drink alone is placed, the receipt can be printed on the drink cup, the drink cup filled, and then delivered to the customer.

Alternatively, the receipt can be printed on an item chosen by the customer. For example, the customer can choose an item from a grocery store, such as a container of detergent, and rather than provide a bag and receipt the clerk can print the receipt directly on the container of detergent.

Perforation may be incorporated as part of the printing process. Perforation of the area containing the receipt information allows for simpler removal of the receipt for storage, business expense reports, etc. while still reducing the quantity of packaging.

The fifth step is combining the ordered goods and the packaging. In some cases this will be placement of the goods into a bag, in others it will be placement of the goods on a tray.

The sixth and final step is to deliver the combined packaging/receipt and goods to the customer.

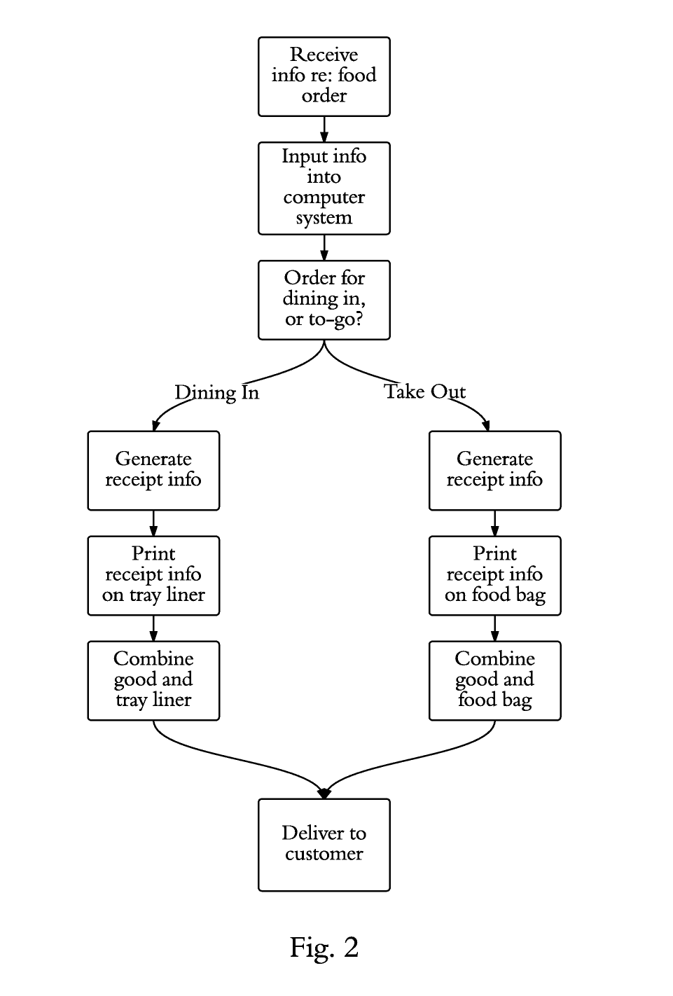

Referring to FIG. 2, a flow diagram of a method within a fast-food restaurant for gathering order information and combining it with the packaging is shown.

The first step is receiving information regarding the desired goods. This can be a customer at a counter telling an employee which menu items are desired, a telephone call from a customer with an order, or information gathered from the internet. Given that these steps are directed toward a fast-food restaurant, the most common method for gathering this information will be a customer at a counter, or within a car at a drive-through. But ordering using smartphones or other computing devices is anticipated.

The second step is inputting this information into a computer system. If the ordering device is electronic, this step may be combined with the first step. For example, a customer may input their order into a smartphone, the smartphone in turn passing the info to the restaurant computer system.

The third step is a determination of whether the order will be for dining within the restaurant, or as a takeout order. An order for dining within the restaurant will result in the receipt being printed on a tray liner, an order for takeout will result in the receipt being printed on a bag.

For either path, the fourth step is generation of the receipt information.

For dining in, the receipt info is intended for a tray liner. The additional space present on the tray liner allows for a greater quantity of receipt information to be printed, as well as coupons specific to the customer's current order or past order. Coupons may be perforated around to provide for easy removal from the packaging.

Advertisements may also be printed on the tray liner near in time to the printing of the receipt. Advertisements may also be perforated around to simplify removal from packaging.

For take out the receipt info is intended for a bag. If space allows, coupons specific to the customer's current or past orders are included, as well as advertisements.

The fifth step is printing the generated receipt information on either the tray liner or bag. This can be performed by any printer that is equipped to print on packaging. A modified printer may be required to deal with the complexity of feeding a paper bag or plastic bag through the path of a printer head. If the printing is to be done on a tray liner, the printing process will be less complex.

The sixth step is combining the ordered goods and the packaging. In some cases this will be placement of the goods into the bag, in others it will be placement of the goods on the tray.

The seventh step is to combine the items of the order with the packaging, either the tray liner or the bag.

The eighth and final step is to deliver the combined packaging/receipt and goods to the customer.

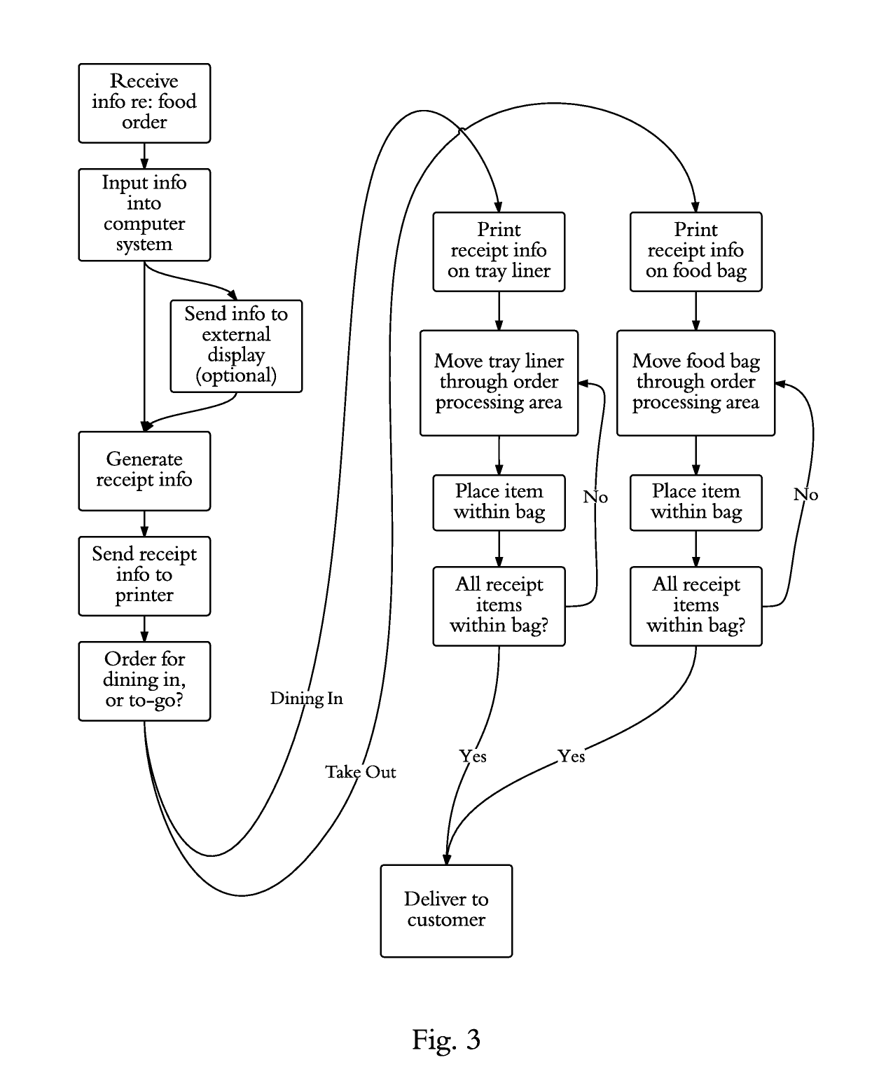

Referring to FIG. 3, a flow diagram of a method for gathering order information and combining it with the packaging before passing it through the order preparation portion of a restaurant is shown.

The first step is receiving information regarding the desired goods. As above, there are many ways that this information could be received, including in-person, over the telephone, internet, etc.

The second step is inputting this information into a computer system. As above, this step may be combined with the first step.

The optional third step is to send the generated receipt info to an external display. This step is useful when there is a portion of the restaurant that would benefit from knowing upcoming orders, such as the grilling portion of the kitchen, but does not require physical packaging on which to place an order.

The fourth step is generation of the receipt info.

For dining in, the receipt info is intended for a tray liner. As above, the greater space available on a tray liner allows for inclusion of advertisements and coupons.

For takeout the receipt info is intended for a bag. As above, despite the limited space, advertisements and coupons are sometimes included.

The fifth step is sending the generated receipt info to the printer.

The sixth step is a determination of whether the order will be for dining within the restaurant, or as a takeout order.

The seventh step is printing the receipt info. An order for dining within the restaurant will result in the receipt being printed on a tray liner, an order for takeout will result in the receipt being printed on a bag.

Steps eight through ten involve putting the food items with the packaging, either the tray liner or food bag. In a restaurant situation this likely involves moving the packaging down a long counter, placing food items on the tray or within the bag as the packaging moves down the counter. If all the items are with the product packaging, then one can skip to step eleven, where the packaging and food item are delivered to the customer. If there are still missing items, then the packaging and food item are moved to the station where such items can be placed with the packaging.

Step eleven is delivery of the completed order to the customer.

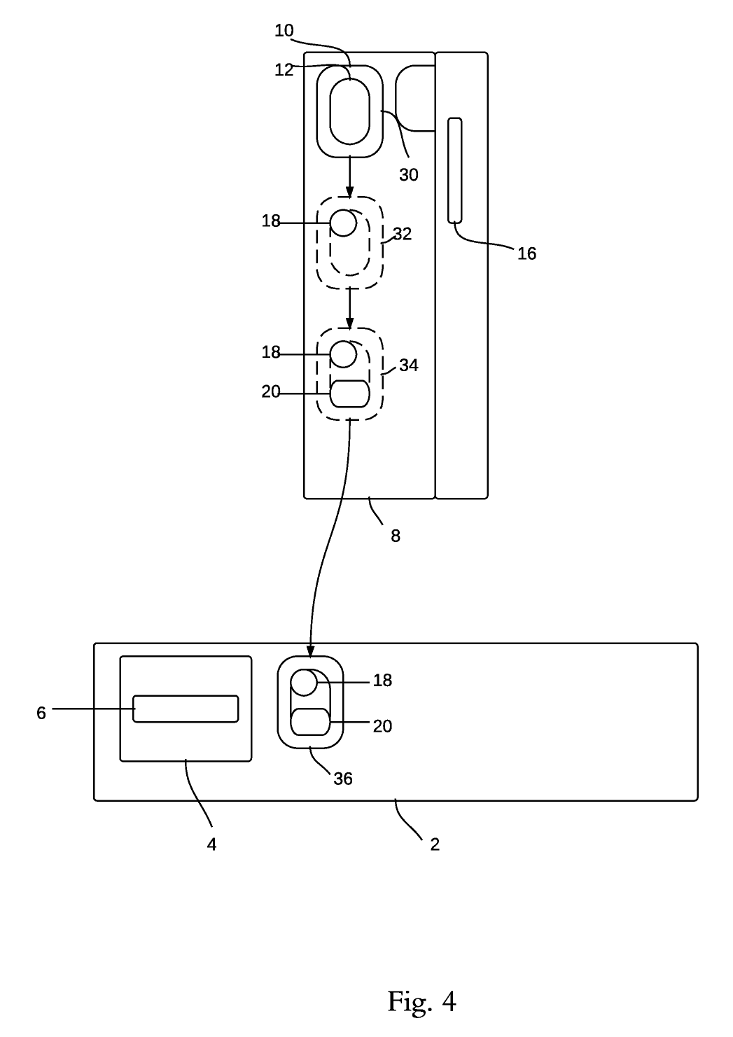

Referring to FIG. 4, an overhead schematic of a restaurant is shown.

The counter 2 represents the front counter of a restaurant, including a Point-Of-Sale (“POS”) device (e.g., cash register) 4 with associated display 6. The prep counter 8 is behind the counter 2. The prep counter 8 includes the optional secondary display 16.

Using the tray with liner as an example, the tray 10 is filled using a liner 12 that includes receipt information from receipt printer 14, printed in accordance with any of the above methods.

The tray 10 starts at position one 30. There the liner 12 is added to the tray 10.

The tray 10 with liner 12 then moves to position two 32. At this position, item one 18 is placed on the tray.

The tray 10 with liner 12 then moves to position three 34. At that position, item two 20 is added is added to item one 18.

With all the necessary items added to the tray 10 with liner 12, the combination is moved to the counter 2 for delivery to the customer.

Applicable to all the figures, the described cash register, register means, or Point-Of-Sale device can be any device capable of computation, including a desktop computer, tablet, laptop, smartphone, or generic mobile POS device.

A POS device need not be operated by an employee, but can also be operated by a customer.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method to join a receipt with a package and package by printing a transaction receipt directly on a package.

2. The method of claim 1, wherein the transaction receipt is printed on a package during a transaction between a business and a customer.

3. The method of claim 1, wherein the transaction receipt comprises receipt information, and the receipt information includes pricing information, quantity information, and a date of purchase.

4. The method of claim 3, wherein the package is a paper bag.

5. The method of claim 3, further comprising the step of perforating the transaction receipt for easy removal.

6. The method of claim 3, wherein the package is a plastic bag.

7. The method of claim 1, comprising the steps of:
a. inputting into a computer processor an order, the order comprising one or more items;
b. creating the transaction receipt from the order;
c. outputting the transaction receipt to a printer;
d. printing the transaction receipt on a package,
e. assembling selected items that make up the customer order;
f. placing selected items into the package; and
g. providing the selected items and package to a customer.

8. A food order fulfillment method comprising the steps of:
a. receiving into a register means, information constituting an itemized food order, the itemized food order including different menu items;
b. transmitting the itemized food order from the register means to a printer; and
c. the printer printing the itemized food order on a package.

9. The receiptless food order fulfillment method of claim 8, wherein the register means is a point-of-sale device.

10. The receiptless food order fulfillment method of claim 8, wherein the package is a fast food tray liner.

11. The receiptless food order fulfillment method of claim 8, wherein the package is an outside surface of a container holding at least one of the different menu items.

12. The receiptless food order fulfillment method of claim 8, further comprising the step of printing an advertisement on the package.

13. The receiptless food order fulfillment method of claim 8, further comprising the step of printing a coupon on the package, and the package is perforated around the coupon immediately before or after the coupon is printed.

14. A method of processing a food order without the printing of a separate receipt, comprising the steps of:
a. receiving information including an itemized food order;
b. inputting the itemized food order into a computer system, the computer system having both data storage and computing capability;
c. generating receipt information from the itemized food order;
d. sending receipt information to a printer; and
e. printing the itemized food order on a package, the package one of one or more packages.

15. The method of claim 14, further comprising the steps of:
a. moving the package through a food processing area, placing at least one item from the itemized food order into the package;
b. verifying that every item from the itemized food order is within the one or more packages; and
c. if items from the itemized food order are not within the package, repeating the steps of moving the package through a food processing area and verifying the items, until all items are present within the package.

16. The method of claim 14, wherein if the itemized food order is take-out, the package is a bag, and if the itemized food order is for dining-in, the package is a tray liner.

17. The method of claim 14, wherein the receipt information includes a product name, a price, a quantity, and a date of purchase.

18. The method of claim 16, further comprising the step of printing an advertisement on the package.

19. The method of claim 16, further comprising the step of printing a coupon on the package, the package perforated around the coupon.

20. The method of claim 14, further comprising the steps of:
a. printing an advertisement on the package;
b. moving the package through a food processing area, placing an item from the itemized food order into the package;
c. verifying that every item from the itemized food order is within the package; and
d. if items from the itemized food order are not within the package, repeating the steps of moving the package through a food processing area and verifying the items, until all items are present within the package.
